(19) United States
(12) Patent Application Publication
(10) Pub. No.: US 2013/0071765 A1
(43) Pub. Date: Mar. 21, 2013

(54) Method for Operating a Fuel Cell System

(71) Applicant: Rainer Bauer, Nordheim (DE)

(72) Inventor: Rainer Bauer, Nordheim (DE)

(73) Assignee: Daimler AG, Stuttgart (DE)

(21) Appl. No.: 13/497,853

(22) PCT Filed: Jul. 16, 2010
(86) PCT No.: PCT/EP2010/004344

§ 371 Date: Dec. 6, 2012

(30) Foreign Application Priority Data
Sep. 25, 2009 (EP) 102009042901.8

(51) Int. Cl. H01M 8/04

(52) U.S. Cl. CPC H01M 8/04671
USPC 429/429

(57) ABSTRACT

A method for operating a fuel cell system for the provision of electrical power is provided. The fuel cell system is disconnected when control electronics detect a fault. The fault that led to the disconnection is evaluated by the control electronics. An automatic restart of the fuel cell system through the control unit occurs if the evaluation of the fault permits this.

### BACKGROUND AND SUMMARY OF THE INVENTION

The invention relates to a method for operating a fuel cell system.

Fuel cell systems are known from the general prior art. They are used to produce electrical power from educts, such as hydrogen and air, via a fuel cell. The fuel cell system can be in particular a fuel cell system with a so-called PEM fuel cell. Such a PEM fuel cell is typically constructed as a stack of individual fuel cells. The anode chamber is separated from the cathode chamber by a proton exchange membrane (PEM). Such systems, which are supplemented with a corresponding device for hydrogen and air supply and possibly further peripheral elements to the fuel cell system, are suited for providing electrical power by means of which a vehicle can be driven.

It is further known from the general prior art that such a fuel cell system has an electronic control unit or control electronics that control(s) the operation of the system and monitor(s) the smooth and safe operation of the system. If faults arise in the fuel cell system an emergency disconnection of the system can take place via the control electronics, typically either due to a fault detected by a sensor system in the area of the hardware or due to a software fault arising in the control sequence of the control electronics.

Generally, such an emergency disconnection of a fuel cell will end in a fault report of the control electronics. This must then typically be manually evaluated by maintenance staff before the system can be started again, possibly after eliminating the fault. This is particularly annoying when using fuel cell systems to provide electrical power in transport means, such as motor vehicles, utility vehicles, buses or similar, as failure of the transport means is associated with an emergency disconnection of the fuel cell system.

Exemplary embodiments of the present invention provide a method for operating a fuel cell system that avoids the abovementioned disadvantages and facilitates operation which is as convenient and safe as possible even in case of faults arising.

According to the invention a fault arising in the fuel cell system is evaluated by the control electronics in order to ascertain which fault has led to a disconnection of the system. If it is detected that the fault is not serious or safety-related an automatic restart of the fuel cell system is carried out directly by the control electronics. In case of non-serious faults and those not affecting safety, a direct automatic restart of the fuel cell system can take place. The down time of the fuel cell system can thus be minimized and a user of the fuel cell system, for example when using this in transport means, does not have to go to a workshop, have the vehicle towed or call out a maintenance engineer before he can use the fuel cell system again. Such resources relating to manual checking, monitoring and restoration of the system are only necessary if the fault leading to the emergency disconnection of the fuel cell system is so serious or affects safety so much that this is absolutely necessary.

In a particularly favorable and advantageous aspect of the method according to the invention the evaluation of the fault comprises a division into predefined fault categories, whereby whether an automatic restart is permitted is stored in the control electronics for each fault category. The disconnection of the fuel cell system as an emergency disconnection is typically caused by certain fault sources that are monitored by the control electronics. Accordingly, the control electronics can identify which sensor, software fault or similar has triggered the fault and thus the emergency disconnection of the fuel cell system. It can be correspondingly stored in a matrix which faults are so serious that the system must remain disconnected in all cases and/or which faults permit a restart of the fuel cell system. In accordance with this division into different fault categories the control electronics will then trigger definitive disconnection of the fuel cell system or use the method according to the invention and—insofar as the fault permits—bring about an automatic restart.

According to a very favorable and advantageous aspect of the invention, the evaluation of the fault comprises determination of the number of individual faults. According to a particularly favorable aspect of the invention, both variants previously described can also be combined so that the number of faults per fault category is determined. This allows very specific monitoring to be realized and, depending upon the seriousness of the fault, thus the respective fault category, it can be ascertained that a restart is to be definitively prevented after a predefined number of repeated faults—possibly in one fault category—solely due to the high number of such fault reports.

According to a particularly favorable and advantageous aspect of the method according to the invention either an electrical energy storage unit or a further fuel cell system is connected in parallel with the fuel cell system. This structure comprising fuel cell system and electrical energy storage unit will thereby be preferred typically for the lower powers in motor cars, while the structure comprising two parallel fuel cell systems, optionally also with an electrical energy storage unit, will be used more in the field of utility vehicles and buses. In both cases it is possible, by means of the electrical energy storage unit and/or the further fuel cell system, to continue to provide at least part of the electrical power while the first fuel cell system is disconnected due to a fault and an automatic restart takes place in this system. A very convenient method for operating the fuel cell system can thus be realized for the user of a corresponding transport means, whereby he does not notice the failure of the fuel cell system that is correspondingly short and can frequently be overcome very rapidly through a restart. A very convenient operation of a transport means equipped with such a fuel cell system can thus be realized.

The method can be used in principle not only in transport means, although these constitute the preferred use of the method according to the invention, but also in stationary systems. In this case too, maintenance intervals can be extended and unplanned maintenance in case of emergency disconnections due to less serious faults can be avoided.

### BRIEF DESCRIPTION OF THE DRAWING FIGURES

Further advantageous embodiments of the invention will become clear using the exemplary embodiment that is described in more detail below by reference to the drawings, in which:

FIG. 1 is a block diagram of a principal representation of a bus as an example transport means; and

FIG. 2 is a flow diagram of an exemplary sequence of the inventive method

### DETAILED DESCRIPTION

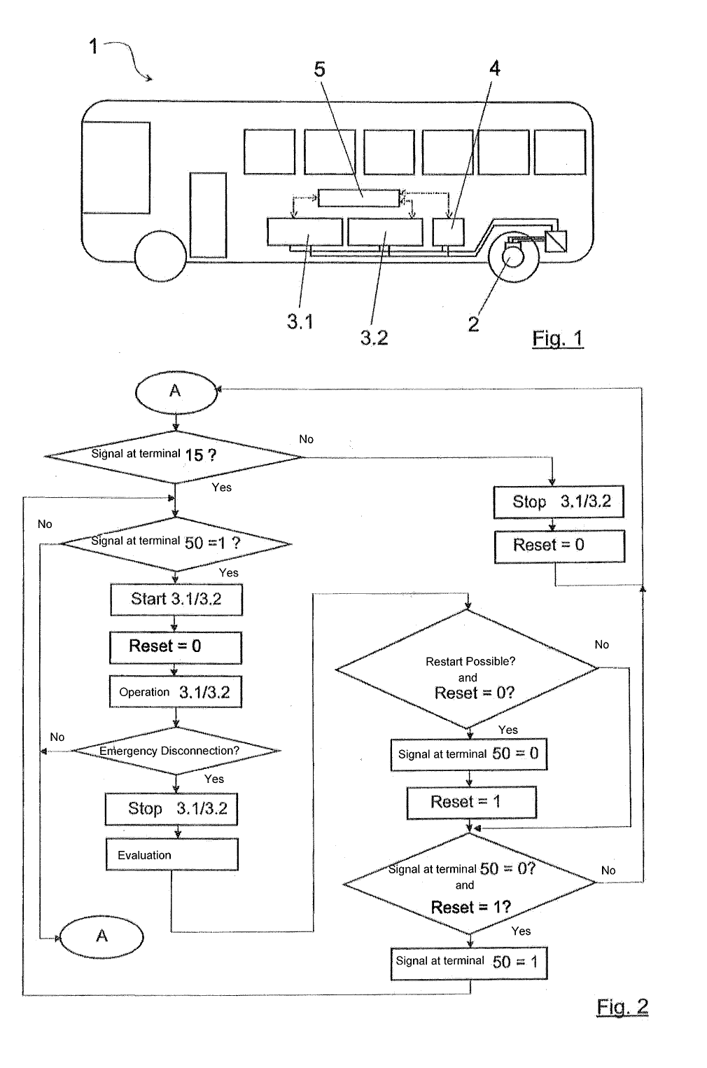

A bus 1 is shown by way of example of a transport means in the illustration of FIG. 1. Bus 1 has an electric motor 2, which is supplied by two parallel fuel cell systems 3.1 and 3.2 with electrical power for driving the bus 1. The two parallel fuel cell systems 3.1, 3.2 also have an energy storage unit 4 arranged in parallel with them. This electrical energy storage unit 4 can be constructed, for example, in the form of a battery and/or in the form of high power capacitors. It can temporarily store energy arising in the fuel cell systems 3.1, 3.2 if this energy is not required to drive the bus 1. In addition, it is possible in the known way for the electric motor 2 to be operated as a generator when the bus 1 brakes in order to achieve a braking effect with its drag torque. The electrical power thereby produced can also be correspondingly stored in the electrical energy storage unit 4. This process is generally described as recuperation.

The two fuel cell systems 3.1, 3.2 are supplied with hydrogen and air by means of supply units which are not shown here. The hydrogen can thereby be conveyed into the bus 1, for example, in a high pressure storage unit (not shown here) or it can possibly be produced from a hydrocarbon-containing starting material on board the bus 1, for example through hot vapor reformation or similar. Irrespectively of the educts used to operate the fuel cell systems 3.1, 3.2 these are controlled and regulated in their sequences by at least one control electronics 5. The control electronics 5 will thereby typically also correspond to vehicle electronics (not shown here), which carry out the energy distribution from both fuel cell systems 3.1, 3.2 and the electrical energy storage unit 4 to the drive motor 2 according to corresponding instructions of the driver of the bus 1 that would be generated for example from accelerator and brake positions.

Faults can repeatedly arise in such complex systems as the fuel cell systems 3.1, 3.2. Since in the fuel cell systems 3.1, 3.2 with the educts—and here in particular hydrogen—comparatively reactive substances are present, it is typically provided in fuel cell systems 3.1, 3.2 that the control electronics 5 monitor the fuel cell systems 3.1, 3.2 and disconnect them in case of a fault. In the conventional systems such an emergency disconnection always led to a complete failure of the fuel cell system 3.1, 3.2 in question, which then had to be eliminated with comparatively high resources by maintenance staff. It has been shown, however, that many of the faults arising are not so serious that an emergency disconnection of the fuel cell system 3.1 or 3.2 is really necessary in each case. A method according to the invention is thus used to operate the fuel cell systems 3.1, 3.2 in the bus 1, whereby this method affords greater convenience and minimizes unnecessary maintenance work on the fuel cell systems 3.1, 3.2 as far as possible.

In the illustration of FIG. 2 such a sequence is shown for a method for operating one of the fuel cell systems 3.1, 3.2. This sequence can be stored in a non-transitory medium in the form of a software program in the control electronics 5 and constitutes only a small part of the whole operating system for the respective fuel cell system 3.1, 3.2. Starting from a start point A the method begins with the determination as to whether a signal is present at the terminal (KL) 15 of the vehicle 1. This means, with the typical number of electrical connecting terminals in a vehicle, that the ignition is on, thus for example an ignition key is in the corresponding position for operation of the vehicle. Instead of an ignition key this can also be realized by a button or similar so that it is inquired in the first selection box whether a corresponding signal is given at the terminal 15 and the bus 1 is thus in operation.

If there is no signal at the terminal 15 the bus 1 has either been parked or has just switched from an operating state into a parked state, thus for example by turning back the ignition key. In this case the respective fuel cell system 3.1, 3.2 is stopped and a reset value is set at zero. Then there is a return to the starting point A in order to await a new connection of the ignition and a signal at the terminal 15. If, however, there is a signal at the terminal 15 in the first selection box, a second selection box follows in which there is a determination regarding a signal at the terminal 50. This terminal 50 is typically the signal to a starter of the bus 1, thus meaning that the fuel cell systems 3.1, 3.2 are to be started. This triggers a start procedure for the fuel cell systems 3.1, 3.2 and also sets a reset value back to zero. During the operation of the fuel cell system 3.1, 3.2, which is indicated by the next box, there are regularly determinations concerning whether an emergency disconnection has been triggered either through the hardware or through the software. If such an emergency disconnection has not taken place there is in turn a jump back to the starting point A and the fuel cell system 3.1, 3.2 remains in operation. If such an emergency disconnection has been detected the stopping of the fuel cell system 3.1 or 3.2 in question takes place in the next method step.

In the next method step the fault having arisen is then evaluated and typically assigned to a certain fault category. A corresponding instruction is stored in the control electronics 5 for each of the disconnection fault categories in question. Faults can arise in the fuel cell systems 3.1 or 3.2 which require a direct emergency disconnection of the fuel cell system 3.1 or 3.2 as the fault is so serious that safe further operation of the fuel cell system 3.1 or 3.2 is no longer possible. It will, however, frequently also arise that faults are placed in categories that are less critical and further operation of the system is still possible. Such instructions are stored for each of the individual fault categories in the control electronics 5. In the next selection box there is accordingly a determination concerning the fault category and the instruction, together with a check of the reset value. If the instruction is such that a restart is possible and the reset value is at zero, thus no restart has been carried out so far, a system stop can be brought about by switching off the signal at the terminal 50. The reset value is then set to 1. If there is no signal for the starter at the terminal 50 and if the reset value is 1—which will be determined in the next determination box—by setting the signal at the terminal 50 a restart of the fuel cell system 3.1 or 3.2, which was affected by the emergency disconnection, can be realized. If these conditions are not correspondingly fulfilled there is always a jump back to the starting position A. In parallel with the determination as to whether a restart is possible and the reset value is set at zero it is also possible to correspondingly carry out a manual restart, for example by actuating an ignition key of the bus 1.

The signal at the terminal 15, which symbolizes the principally connected ignition of the bus 1, remains on during this operation, as the process takes place automatically and does not require any intervention of the driver of the bus 1.

It would additionally be possible for the number of faults, either in total, but in particular for each fault category, to be correspondingly counted. By means of an additional enquiry loop it could be ensured that, for example, an automatic restart of the fuel cell system in question 3.1 or 3.2 takes place on the basis of one and the same fault for example three times one after the other before a definitive disconnection of the affected fuel cell system 3.1 or 3.2 takes place, which then necessitates maintenance by service personnel.

With the structure of a bus 1 described above with two fuel cell systems 3.1 and 3.2 and possibly an electrical storage unit 4, such a sequence can thereby take place in one of the fuel cell systems 3.1 or 3.2 while the power or a large part of the power is provided by the other fuel cell system 3.2 or 3.1 and/or the electrical energy storage unit 4. Since the power requirement during the overwhelming majority of vehicle operation takes place in the part load region, an automatic restart of a fuel cell system 3.1 or 3.2 disconnected due to a fault is generally possible without the driver of the bus 1 noticing this, meaning that a very convenient and pleasant operation of the fuel cell systems 3.1 and 3.2 can be realized for the driver of the bus 1.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-11. (canceled)

12. A method for operating a fuel cell system for providing electrical power, the method comprising:
identifying, by control electronics, that a fault of the fuel cell system has occurred;
disconnecting, by the control electronics, the fuel cell system wherein it is determined that a fault has occurred;
evaluating, by the control electronics, the fault that led to the disconnection; and
automatically restarting the fuel cell system, by the control electronics, if the evaluation of the fault determines that automatic restarting is permitted.

13. The method according to claim 12, wherein a plurality of predefined fault categories are stored in the control electronics along with an indication of whether an automatic restart is permitted, and the evaluation of the fault includes identifying the predefined fault category corresponding to the fault that led to the disconnection.

14. The method according to claim 13, wherein the evaluation of the fault includes detection of a number of faults.

15. The method according to claim 14, wherein the evaluation of the fault includes detection of number of faults for each fault category.

16. The method according to claim 13, wherein if certain predefined faults or numbers of faults occur in one fault category, a restart of the fuel cell system is prevented by the control electronics.

17. The method according to claim 16, wherein if restart is prevented a maintenance warning message is generated and displayed.

18. The method according to claim 12, wherein an electrical energy storage unit is arranged in parallel with the fuel cell system, the electrical energy storage unit facilitates supply of electrical power, at least in part, during the restart of the fuel cell system or when it has been disconnected.

19. The method according to claim 12, wherein a further fuel cell system is arranged in parallel with the fuel cell system, the further fuel cell system facilitating supply of electrical power, at least in part, during the restart of the fuel cell system or when it has been disconnected.

20. The method according to claim 19, wherein the control electronics control the further fuel cell system so that a fault leading to disconnection of the further fuel cell system is evaluated and the further fuel cell system is automatically restarted if the evaluation of the fault determines that automatic restarting is permitted.

21. The method according to claim 12, wherein the fuel cell system is part of an electrical drive power in a transport means.

22. The method according to claim 21, wherein the transport means is a bus and the bus includes two parallel fuel cell systems.
